(19) United States
(12) Patent Application Publication
(10) Pub. No.: US 2023/0088039 A1
(43) Pub. Date: Mar. 23, 2023

(54) SYSTEM AND METHOD FOR REMOVING HYDROGEN SULFIDE FROM GAS

(71) Applicant: Marcus William SCHULZ, Calgary (CA)

(72) Inventor: Marcus William SCHULZ, Calgary (CA)

(21) Appl. No.: 17/902,794

(22) Filed: Sep. 2, 2022

Related U.S. Application Data
(60) Provisional application No. 63/243,797, filed on Sep. 14, 2021.

(51) Int. Cl. B01D 53/52; C10L 3/10

(52) U.S. Cl. CPC B01D 53/52; C10L 3/103; B01D 2257/304; B01D 2256/245; C10L 2290/545

(57) ABSTRACT

A system and method for removing hydrogen sulfide from natural gas using a triazine scavenger is described. The system includes a pre-treatment system that can be connected to an existing hydrogen sulfide removal system to more fully utilize the triazine scavenger. The pre-treatment system includes a contactor vessel in which sour natural gas is contacted with fresh and/or partially consumed scavenger to partially sweeten the sour gas by removing H₂S. The partially sweetened gas then flows to the existing hydrogen sulfide removal system where it is fully sweetened.

### PRIORITY

The present application is related to and claims the priority benefit of U.S. Provisional Patent Application No. 63/243,797 filed Sep. 14, 2021, the content of which is hereby expressly incorporated by reference in its entirety into this disclosure.

### TECHNICAL FIELD

The disclosure relates to the purification of gases, and more specifically to the removal of hydrogen sulfide from natural gas using a chemical scavenger.

### BACKGROUND

### Hydrogen Sulfide as a Contaminant in Natural Gas

Hydrogen sulfide (H₂S) is a light, volatile compound that is a poisonous and corrosive contaminant of natural gas and crude petroleum. While only relatively small amounts of H₂S occur in crude petroleum, natural gas can contain up to 40% by volume. As a result, H₂S must be removed to acceptable levels prior to delivery to a refinery or main gas distribution system. Generally, in order to meet governmental, technical and natural gas sales specifications, H₂S concentrations must be at very low levels (usually <4 ppm).

Natural gas containing a high concentration of sulfur is commonly referred to as sour gas. Removing H₂S from sour gas is referred to as gas sweetening. Natural gas is generally considered sour if there are more than 5.7 mg of H₂S per cubic meter of natural gas, which is equivalent to approximately 4 ppm by volume under standard temperature and pressure.

Hydrogen sulfide is a covalent hydride structurally related to water (H₂O) as oxygen and sulfur occur in the same periodic table group. However, hydrogen sulfide is weakly acidic, dissociating in aqueous solution into hydrogen cations H⁺ and the hydrosulfide anion HS^{-l :}

H₂S→HS⁻+H⁺

Hydrogen sulfide reacts with many metals cations to produce the corresponding metal sulfides.

### Chemical Scavengers Used for Removing H₂S

In oil and gas processing, chemical scavengers are often used for removing H₂S from natural gas. Chemical scavengers are broadly divided into regenerative and non-regenerative H₂S scavengers.

Regenerative scavengers comprising an amine solution are commonly used in large production facilities for sweetening sour natural gas. These processes are known simply as the ‘amine processes’, or alternatively as the Girdler process, and are commonly used in North American gas sweetening operations. Generally, the sour gas is run through a tower, which contains the amine solution. The amine solution has an affinity for sulfur and absorbs it much like glycol absorbing water. There are several amine solutions that are commonly used, including monoethanolamine (MEA), methyldiethanolamine (MDEA), and diethanolamine (DEA), each of which in their liquid form will absorb sulfur compounds from natural gas as it passes through the column. The effluent gas or sweet gas is virtually free of H₂S compounds. Like the process for NGL extraction and glycol dehydration, the amine solution used can be regenerated (that is, the absorbed sulfur is removed), allowing it to be reused to treat more sour gas. This technology is relatively capital intensive and is generally more suitable for larger scale operations.

In other systems, non-regenerative H₂S scavengers are used to sweeten natural gas. Non-regenerative scavengers include triazine, solid scavengers (generally zinc or iron-based materials), oxidizing chemicals (e.g. NaClO₂, NaBrO₃, NaNO₂, etc.) aldehydes (e.g. glyoxal), and metal carboxylates and chelates. Scavengers react with H₂S to eliminate it and sweeten the gas, typically in a contact tower or by direct in-line injection. The resulting “spent” scavenger is then separated from the sweetened gas and disposed of.

### Triazine-Based Scavengers

Triazine-based scavengers are the most commonly used non-regenerative liquid scavengers for sweetening natural gas. A triazine is one of three organic chemicals with a 6-member cyclic molecule with the formula C₃H₃N₃. The three isomers of triazine, as shown below, differ based on the positions of their nitrogen atoms and are referred to as 1,2,3-triazine, 1,2,4-triazine, and 1,3,5-triazine.

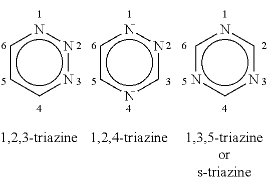

Variations of triazine exist involving substitutions of the hydrogen atoms with other functional groups to result in different reactivity with H₂S and changes in solubility of triazine and/or the reactant products. Triazine-based scavengers are generally composed of a reacted product of an aldehyde and ethanolamine. The most common triazine scavenger is an amine-aldehyde condensate manufactured by an exothermic reaction of monoethanolamine (MEA) and formaldehyde. Water and methanol are usually required to keep the formaldehyde in solution and prevent polymerization. The resulting “scavenger” product is a hexahydrotriazine and is usually just referred to as “triazine” in the industry. The “triazine” is typically offered in a water-based solution.

Triazine-based scavengers react specifically with H₂S and light mercaptans, using a substitution reaction that is not reversible and has a limited uptake capacity. Triazine may reduce H₂S concentrations to as low as 0 ppm and partially remove some light mercaptans (methyl, ethyl and propyl).

One mole of triazine scavenger has three reaction sites, each of which can react with one mole of H₂S. The first two reactions occur very fast to form dithiazine, and the third reaction is somewhat slower to forms trithiazine. The three reactions are shown in FIG. 7 with respect to monoethanolamine (MEA) triazine, which is a commonly used triazine scavenger. Dithiazine is soluble in water and methanol under normal conditions. Trithiazine (also called trithiane) is generally insoluble and precipitates out of the solution.

During gas sweeting with triazine, the optimal reaction is for two H₂S molecules to react with 100% of the triazine to form dithiazine. This is referred to as a 100% spent reaction or a reaction with 100% efficiency, wherein the triazine is “fully consumed” or “fully spent”. If the reaction goes beyond this to the third reaction where a third H₂S molecule reacts with triazine to form trithiazine, the triazine is considered “overspent”. “Overspending” is generally avoided because trithiazine precipitates out of solution and settles in equipment which creates problematic build-up and plugs line in gas processing systems and downstream systems. Trithiazine can be difficult to remove from equipment and lines, and generally needs to be removed with mechanical means.

Triazine scavenger systems for removing H₂S have a relatively low capital equipment cost, but the cost of the chemical scavenger is relatively high, for example $3 to $10 per gallon. This results in the overall process cost of H₂S removal from about $5 to $15 USD per pound of H₂S removed. The triazine scavenger system is generally the preferred system for offshore gas treatment and onshore sites where there is a relatively small amount of H₂S that needs to be treated.

There continues to be a need for a technology that improves the efficiency of utilization of scavenger reagent, such that the overall process economics can be improved.

### SUMMARY

In accordance with the disclosure, there are provided methods and systems for removing hydrogen sulfide from natural gas and for retrofitting existing gas sweetening systems.

In accordance with one aspect of the disclosure, there is provided a method for removing hydrogen sulfide from natural gas comprising the following steps in any order:
a. reacting a sour natural gas with a partially consumed triazine-based scavenger to produce a partially sweetened natural gas and a partially and/or fully consumed scavenger, wherein in fully consumed scavenger, three reaction sites of triazine molecules have undergone a sulfur molecule substitution to form trithiazine;
b. separating the partially sweetened natural gas from the partially and/or fully consumed scavenger;
c. separating any fully consumed scavenger from the partially and/or fully consumed scavenger, including separating any trithiazine that has precipitated out;
d. reacting the partially sweetened natural gas from step a) with a fresh triazine-based scavenger to produce a sweetened natural gas and a second partially consumed scavenger; and
e. separating the sweetened natural gas from the second partially consumed scavenger.

The second partially consumed scavenger produced in step d) may be used as at least part of the partially consumed triazine-based scavenger for step a). In step a), a second fresh triazine-based scavenger may be reacted with the sour natural gas along with the partially consumed triazine-based scavenger.

In step c), separating any fully consumed scavenger may include separating out byproducts created during the reaction of the scavenger with hydrogen sulfide. After the fully consumed scavenger has been separated from the partially and/or fully consumed scavenger in step c), any remaining partially consumed scavenger may be re-used in step a) for reacting with the sour natural gas.

The amount of the fresh triazine-based scavenger provided in step d) may be controlled based on a hydrogen sulfide concentration of the partially sweetened natural gas to prevent the fresh triazine-based scavenger from being fully consumed when the sweetened natural gas is produced.

In one aspect of the disclosure, there is provided a system for removing hydrogen sulfide from natural gas comprising:

a first vessel for receiving a sour natural gas and a partially consumed triazine-based scavenger, wherein the partially consumed triazine-based scavenger reacts with the sour natural gas to produce a partially sweetened natural gas and a partially and/or fully consumed scavenger, wherein in fully consumed scavenger, three reaction sites of triazine molecules have undergone a sulfur molecule substitution to form trithiazine;

a second vessel operatively connected to the first vessel for receiving the partially sweetened natural gas from the first vessel and a fresh triazine-based scavenger, the fresh triazine-based scavenger reacting with the partially sweetened natural gas to produce a sweetened natural gas and a second partially consumed scavenger;

a first separation vessel operatively connected to the first vessel for receiving the partially and/or fully consumed scavenger from the first vessel and separating any fully consumed scavenger, including any trithiazine that has precipitated out from the consumed scavenger;

a scavenger delivery system operatively connected to the first vessel and the second vessel for delivering the partially consumed triazine-based scavenger to the first vessel and the fresh triazine-based scavenger to the second vessel; and

a control system controlling a flow of the fresh triazine-based scavenger to the second vessel based on a hydrogen sulfide concentration in the partially sweetened natural gas to prevent the fresh triazine-based scavenger in the second vessel from being fully consumed when the sweetened natural gas is produced.

The system may comprise a second separation vessel operatively connected to the second vessel for receiving and separating the sweetened natural gas and the partially consumed scavenger. The sweetened natural gas and the partially consumed scavenger may be separated from each other in the second vessel. The second partially consumed scavenger produced in the second vessel may be introduced into the first vessel as at least part of the partially consumed triazine-based scavenger via the scavenger delivery system.

In the system, separating the fully consumed scavenger may include separating any byproducts formed by the reaction of the partially consumed triazine-based scavenger with hydrogen sulfide.

In the system, the control system may comprise a hydrogen sulfide sensor operatively connected between the first vessel and the second vessel for measuring the hydrogen sulfide concentration in the partially sweetened natural gas exiting the first vessel, and wherein the control system is responsive to the hydrogen sulfide concentration exiting the first vessel to increase or decrease the flow of the fresh triazine-based scavenger to the second vessel. The control system may be responsive to the hydrogen sulfide concentration exiting the first vessel to increase or decrease the flow of the partially consumed triazine-based scavenger to the first vessel.

In the system, the first vessel may receive a second fresh triazine-based scavenger for reacting with the sour natural gas along with the partially consumed triazine-based scavenger.

Any partially consumed scavenger in the first separation vessel may be recirculated back into the first vessel for further reaction with the sour natural gas.

The first vessel may comprise:

a first inlet for receiving the sour natural gas;

a second inlet for receiving the partially consumed triazine-based scavenger;

a contacting member inside the first vessel, wherein the contacting member includes a cavity for reacting the sour natural gas with the partially consumed triazine-based scavenger;

a separation member inside the first vessel for causing the separation of the partially sweetened natural gas from the partially and/or fully consumed scavenger;

a gas outlet through which the partially sweetened gas exits the first vessel; and

a second outlet through which the partially and/or fully consumed scavenger exits the first vessel.

The contacting member may include a wall separating the cavity from a channel, wherein the partially and/or fully consumed scavenger flows from the separation member to the second outlet through the channel. The contacting member may be a tube-shaped member, wherein the cavity is inside the wall and the channel is outside the wall. The separation member may be a perforated plate.

In one aspect of the disclosure, there is provided a system for retro-fit connection to an existing gas sweetening system, the system for pre-treating natural gas prior to the natural gas entering the existing gas sweetening system, the system comprising:

a first vessel for operative connection to the existing gas sweetening system, the first vessel for receiving a sour natural gas and a partially consumed triazine-based scavenger, wherein the partially consumed triazine-based scavenger reacts with the sour natural gas to produce a partially sweetened natural gas and a partially and/or fully consumed scavenger, wherein the partially sweetened natural gas is transported to the existing gas sweetening system for further treatment; wherein in fully consumed scavenger, three reaction sites of triazine molecules have undergone a sulfur molecule substitution to form trithiazine;

a first separation vessel operatively connected to the first vessel for receiving the partially and/or fully consumed scavenger from the first vessel and separating any fully consumed scavenger, including trithiazine that has precipitated out from the partially and/or fully consumed scavenger; and

a scavenger delivery system operatively connected to the first vessel for delivering the partially consumed triazine-based scavenger to the first vessel.

The partially consumed triazine-based scavenger received in the first vessel may be received from the existing gas sweetening system where it became partially consumed during operations in the existing gas sweetening system.

The operative connection of the first separation vessel and the first vessel may allow for any partially consumed scavenger from the first separation vessel to be recirculated back to the first vessel for further reaction with the sour natural gas.

In one aspect of the disclosure, there is provided a method for retrofitting an existing gas sweetening system to include a pre-treatment system, comprising the following steps in any order:

providing a first vessel and operatively connecting the first vessel to the existing gas sweetening system, the first vessel for receiving a sour natural gas and a partially consumed triazine-based scavenger to react the partially consumed triazine-based scavenger with the sour natural gas to produce a partially sweetened natural gas and a partially and/or fully consumed scavenger, wherein in consumed scavenger, three reaction sites of triazine molecules have undergone a sulfur molecule substitution to for trithiazine; and

providing a first separation vessel and operatively connecting the separation vessel to the first vessel, the first separation vessel for receiving the partially and/or fully consumed scavenger and separating any fully consumed scavenger, including trithiazine that has precipitated out from the partially and/or fully consumed scavenger;

wherein the operative connection of the first vessel to the existing gas sweetening system allows for the flow of partially sweetened natural gas from the first vessel to the existing gas sweetening system for further treatment.

The partially consumed triazine-based scavenger may be provided from the existing gas sweetening system.

### BRIEF DESCRIPTION OF THE DRAWINGS

Various objects and features of the disclosure will be apparent from the following description of particular embodiments of the disclosure, as illustrated in the accompanying drawings. The drawings are not necessarily to scale, emphasis instead being placed upon illustrating the principles of various embodiments of the disclosure. Similar reference numerals indicate similar components.

FIG. 1 is a schematic diagram of a natural gas sweetening system using a scavenger in accordance with the prior art.

FIG. 2 is a schematic diagram of a natural gas sweetening system with a polishing system in accordance with the prior art.

FIG. 3 is a schematic diagram of a natural gas sweetening system using a scavenger in accordance with one embodiment.

FIG. 4 is a side internal view of a vessel comprising a pre-treatment contactor for natural gas sweetening in accordance with one embodiment.

FIG. 5 is top view of a liquid distributor in the contactor of FIG. 4.

FIG. 6 is a bottom view of a gas sparger in the contactor of FIG. 4.

FIG. 7 is a diagram of the chemical reaction of MEA triazine with H2S in accordance with known reactions in the prior art.

### DETAILED DESCRIPTION

### Rationale

With reference to the figures, systems and methods for removing H₂S from natural gas are described.

In past systems, the reaction of triazine and H₂S was ideally controlled to consume the triazine scavenger as much as possible without overspending it, which meant reacting two moles of H₂S with one mole of triazine to form dithiazine, to the fullest extent possible, while avoiding any reaction of a third mole of H₂S to form trithiazine, since trithiazine would precipitate out of the solution and cause problems. Practically speaking, it can be very challenging to obtain the ideal extent of the reaction at all times due to fluctuations in H₂S levels in natural gas. In order to avoid overspending the triazine, the triazine is often underreacted, leaving some reaction sites in the triazine unreacted (i.e. not substituted with sulfur molecules). Since triazine is not reusable and is typically the most expensive part of the natural gas sweetening process, not fully utilizing the triazine can unnecessarily increase processing costs.

The inventor has realized the need to improve the systems and methods for sweetening natural gas with triazine scavenger to fully utilize the capacity of the scavenger to provide a more cost-effective system and method. The systems and methods are now described with reference to the figures.

For the purposes of illustration, components depicted in the figures are not necessarily drawn to scale. Instead, emphasis is placed on highlighting the various contributions of the components to the functionality of various aspects of the disclosure. A number of possible alternative features are introduced during the course of this description. It is to be understood that, according to the knowledge and judgment of persons skilled in the art, such alternative features may be substituted in various combinations to arrive at different embodiments of the present disclosure.

### Prior Art Systems

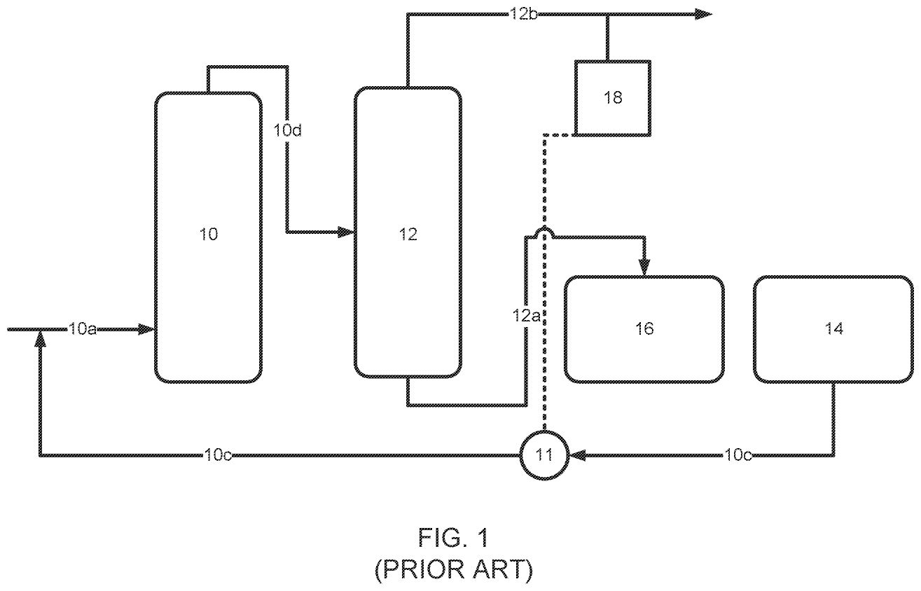

A typical prior art system used for sweetening natural gas using a triazine scavenger is illustrated in FIG. 1. The system includes a contactor column 10 and separator 12. Sour gas 10a is introduced into the contactor column 10 together with liquid scavenger 10c from a fresh scavenger source 14, such as a storage tank, by pump 11. The sour gas and scavenger pass upwardly through the column as the sour gas and scavenger react to remove H₂S from the gas, thereby sweetening the gas and consuming the scavenger. The sweetened gas and consumed scavenger liquid 10d collectively pass out of the top of the column and enter separator 12 whereby the sweetened gas and consumed liquid scavenger are separated on the basis of density. The consumed liquid scavenger 12a is removed from the bottom of the separator 12 and delivered to a consumed scavenger tank 16 for disposal. The sweetened gas 12b is removed from the top of the separator 12 for delivery. The system is controlled by an appropriate control and feedback system 18 to monitor the H₂S concentration in the sweetened gas 12b and to control the flow of scavenger to the contactor column 10 through pump 11.

In the prior art system, the triazine scavenger is added in significant excess to ensure that the H₂S is fully removed and that the scavenger does not overreact and form a solid precipitate, but instead stays in liquid form. Due to normal fluctuations in the H₂S concentration entering the column 10, and to provide an appropriate margin to ensure the gas is fully sweetened but the scavenger is not overreacted, significant amounts of scavenger delivered to the consumed scavenger tank 16 are not fully reacted.

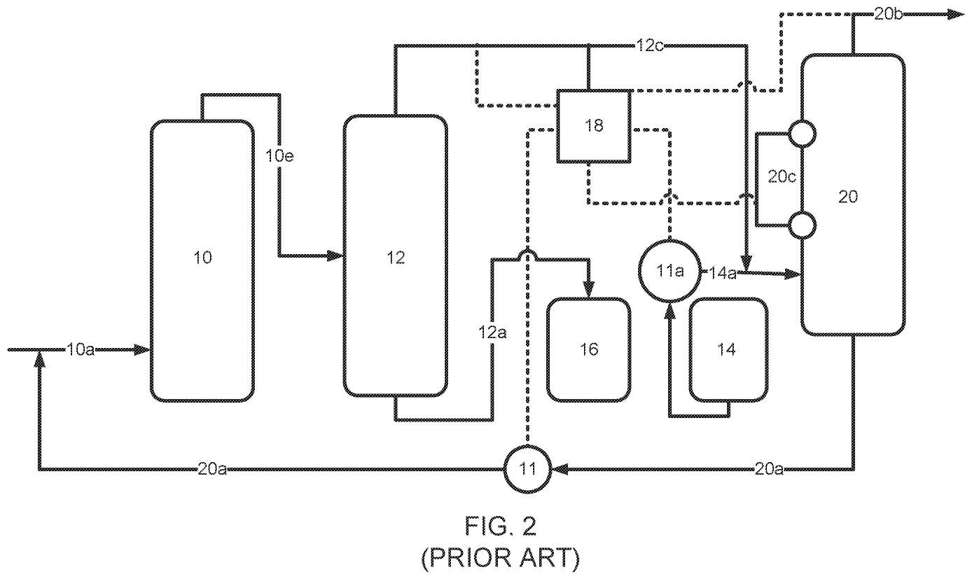

The inventor previously came up with a “polishing system” that is described in U.S. Pat. No. 7,935,323 and is used in conjunction with the prior art system described above to more efficiently utilize the scavenger. One embodiment of the polishing system is illustrated in FIG. 2, where there is a second column 20 that functions similarly to contactor column 10, except that it is operated as a combined reactor and separator. In this case, in the contactor column 10 the sour gas is only partially sweetened (i.e. is “semi-sweet”), after which the partially sweetened gas and consumed scavenger 10e flow into the separator 12, with the consumed liquid scavenger 12a exiting the separator into the consumed scavenger tank 16. The partially sweetened gas 12c flows from the separator 12 to the second column 20 for “polishing” where it reacts with fresh liquid scavenger 14a from scavenger source 14 and becomes fully sweetened, converting the fresh scavenger 14a to partially consumed scavenger 20a. The fully sweetened gas 20b exits the top of the column 20. The partially consumed liquid scavenger 20a flows from the second column 20 to the first contactor column 10, where it is fully consumed. The control systems 18, 20c control pumps 11, 11a to balance the flow through the system based on measured H₂S concentrations.

### The Subject System

The subject system adds a pre-treatment system to an existing gas sweetening system. The pre-treatment system is designed to “overspend” the triazine scavenger to force a third mole of H₂S to react with the scavenger to form trithiazine which is insoluble and precipitates out of the liquid. Overspending a scavenger to form a precipitate has been avoided in prior art triazine scavenger systems, as discussed above, due to the problems the buildup of precipitate causes in equipment and pipelines. However, the inventor has come up with a system that forces overspending of the scavenger and which can handle the precipitate without negatively impacting the existing gas sweetening system and downstream piping. This allows for triazine scavenger to be more fully utilized for removing H₂S, thereby decreasing the amount of scavenger required to remove a certain amount of H₂S from gas, and decreasing costs.

### Existing Gas Sweetening System

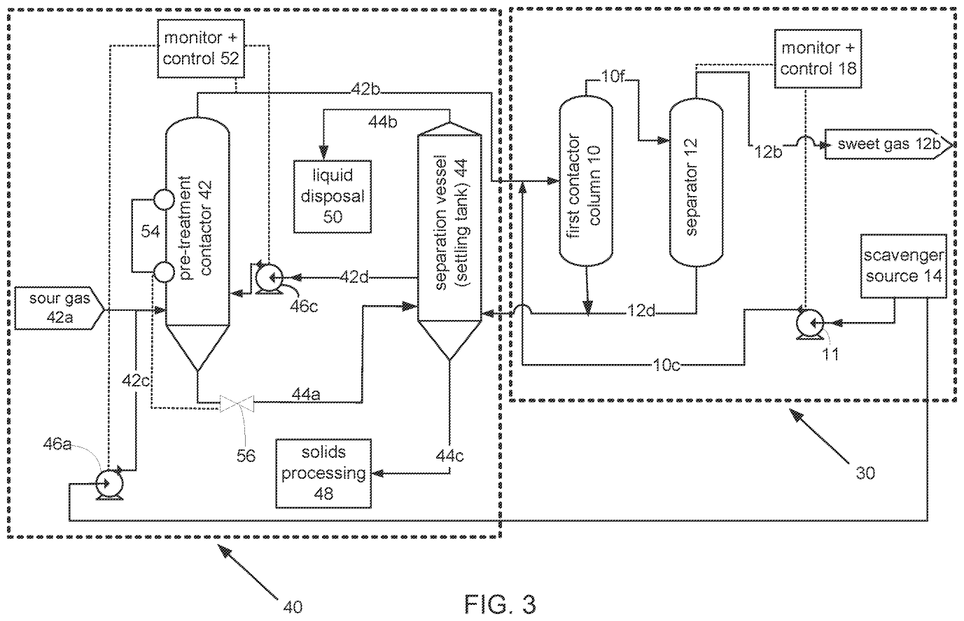

The improved system is illustrated in FIG. 3, in which an existing gas sweetening system 30 is modified to include a pre-treatment system 40. Like the system in FIG. 1, the existing gas sweetening system 30 includes a contactor column 10, a separator 12, a pump 11 and a monitor and control system 18 to control the pump 11 based on measured H₂S levels leaving the separator 12. However instead of sour gas entering the contactor column 10, partially sweetened gas 42b from the pre-treatment system 40 enters the contactor column 10 where it reacts with fresh scavenger 10c to fully sweeten the gas. The sweet gas and partially consumed scavenger 10f then flow from the contactor column 10 to the separator 12 where they are separated by density to form sweetened gas 12b that flows out of the top of the separator, and partially consumed scavenger 12d. The partially consumed scavenger 12d then flows from the separator to the pre-treatment system 30 where it is fully consumed. This differs from the prior art systems where the used scavenger 12a exiting the separator 12 flowed into a consumed scavenger tank.

The contactor column 10 may include internal screens and random packing to force contact between the gas and scavenger in the column. Gas and scavenger enter the column at the bottom, flow up through the column as they react to sweeten the gas, then exit the top of the column.

The contactor column 10 and separator 12 have been illustrated and described as being two separate vessels, however they may also be combined into one vessel which acts as both a contactor and a separator.

### Pre-Treatment System

The pre-treatment system 40 includes a first vessel 42 which is also referred to as a pre-treatment contactor herein, and a first separation vessel 44, which is also referred to as a settling tank. In the pre-treatment contactor 42, sour gas is reacted with fresh triazine scavenger and/or partially consumed triazine scavenger to partially sweeten the gas before it flows to the existing gas sweetening system 30. The partially-sweetened gas is then fully sweetened in the existing gas sweetening system 30 by contacting it with fresh scavenger.

The existing gas sweetening system 30 uses a large excess of fresh scavenger to ensure that the scavenger is not fully consumed (i.e. not overspent) in the existing gas sweetening system 30, thereby preventing precipitate from forming which prevents problematic build-up in the existing gas sweetening system and downstream systems.

The pre-treatment system 40 reacts scavenger and sour gas in the pre-treatment contactor 42 to force the third reaction between the scavenger and H₂S, creating trithiazine. The trithiazine is then precipitated out in the separation vessel 44 of the pre-treatment system, which may be a settling tank, after which the trithiazine precipitate is processed and disposed of.

In reference to the subject system shown in FIG. 3:
“Scavenger” refers to a triazine-based chemical in solution form comprising triazine formed from a reaction of an aldehyde and ethanolamine. Other additives are typically present to affect the properties of the chemical, which may include scale inhibitors, anti-foam agents, excess aldehyde or amine, water and methanol.
“Fresh” scavenger refers to triazine scavenger that has not reacted with H₂S at all. This means that all three reaction sites on each triazine molecule have not undergone a sulfur molecule substitution. Theoretically, 0% of the scavenger has reacted.
“Fully consumed” scavenger refers to triazine scavenger in which all three reaction sites on each triazine molecule have undergone a sulfur molecule substitution. This means that 3 moles of H₂S have reacted with one mole of triazine to form trithiazine, which is insoluble and precipitates out of the liquid scavenger. Theoretically, 100% of the uptake capacity of the scavenger with respect to the three reaction sites has been reached. In practicality, there may still be some unreacted reaction sites. This state of being “fully consumed” has previously been referred to as “overspent” in reference to prior art scavenging systems and in the background.
“Partially consumed” scavenger refers to triazine scavenger in which some triazine has reacted with H₂S, but there is still remaining capacity for reaction. One or two reaction sites on some or all of the triazine molecules have been substituted with sulfur to form soluble molecules thiadiazine and dithiazine. In the partially consumed scavenger, the third reaction site has generally not reacted so that trithiazine precipitate is not formed and the scavenger is still in liquid form.
“Sour gas” generally refers to natural gas with a H₂S concentration of about >4 ppm by volume under standard temperature and pressure (about >5.7 mg of H₂S per cubic meter of natural gas).
“Sweet gas” generally refers to natural gas with a H₂S concentration of about ≤4 ppm by volume under standard temperature and pressure (about ≤5.7 mg of H₂S per cubic meter of natural gas).
“Partially sweetened gas” generally refers to sour natural gas that has undergone a sweetening process to remove some H₂S, but may need further sweetening to become sweet gas.

Referring to FIG. 3, sour gas 42a and fresh scavenger 42c from scavenger source 14 flow into the pre-treatment contactor 42, along with partially consumed scavenger 42d from the settling tank 44. Alternatively, or in addition, partially consumed scavenger can enter the pre-treatment contactor 42 from another source besides the separation vessel 44. For example, partially consumed scavenger can enter the pre-treatment contactor 42 directly from the separator 12 of the existing gas sweetening system 30 or from another source such as a storage tank of partially consumed scavenger.

The sour gas 42a reacts with the scavenger 42c, 42d in the pre-treatment contactor 42 to produce partially sweetened gas 42b. The reacted scavenger then flows to the settling tank 44 as partially/fully consumed scavenger 44a. The partially/fully consumed scavenger 44a may include partially consumed scavenger and/or fully consumed scavenger, depending on the extent it has reacted in the pre-treatment contactor. The partially/fully consumed scavenger 44a is preferably in liquid form but may include solids where trithiazine from fully consumed scavenger has already precipitated out. The settling tank 44 may also receive partially consumed scavenger 12d in liquid form from the existing gas sweetening system 30 (for example, from the separator 12) and/or from another source, which is then directed into the pre-treatment contactor where it can be fully consumed. Alternatively, or in addition, the partially consumed scavenger 12d from the existing gas sweetening system 30 and/or from another source can be directly introduced into the pre-treatment contactor 42 without going through the settling tank 44.

In the settling tank 44, the partially/fully consumed scavenger 44a from the pre-treatment contactor 42 and any partially consumed scavenger 12a that has entered the settling tank 44 from another source reside to allow trithiazine to precipitate out from the liquid scavenger. The solids 44c (i.e. the precipitated trithiazine) are then removed from the settling tank 44, for example through an outlet/drain at the bottom of the tank, after which they can flow to a solids processing system 48 where they are treated (typically dehydrated) and disposed of. The residence time of the scavenger in the settling tank 44 varies depending on the volume of scavenger in the settling tank 44 and the extent to which it is reacted, i.e. the ratio of fully consumed scavenger to partially consumed scavenger. In a typical system, the residence time is from about 30 minutes to about 6 hours. If the scavenger in the settling tank comprises only partially consumed scavenger, no or very low residence time in the settling tank may be needed.

The liquid scavenger in the settling tank 44 is separated based on density, with the less dense liquid byproducts 44b (e.g. water, MEA) of the partially/fully consumed scavenger 44a exiting the settling tank, preferably through an outlet at or near the top of the settling tank, and going to a liquid disposal 50. The denser liquid, being partially consumed scavenger 42d that hasn't been fully consumed, is circulated back to the pre-treatment contactor 42 for further reaction with natural gas in the pre-treatment contactor. By circulating the scavenger between the pre-treatment contactor 42 and the settling tank 44, the scavenger can be fully consumed in the pre-treatment contactor 42 while removing precipitate in a controlled manner from the settling tank 44 to prevent precipitate build-up in the system.

The pre-treatment system 40 includes one or more pumps to move the scavenger through the system. The pre-treatment system also includes a monitoring and control system 52 to monitor the level of H₂S in the partially sweetened gas 42b leaving the pre-treatment contactor and to control the pumps, which may include pumps 46a and 46c for pumping fresh scavenger 42c and partially consumed scavenger 42d, respectively, into the pre-treatment contactor 42.

The pre-treatment contactor 42 may include a level controller 54 to monitor and maintain a certain level of scavenger in the pre-treatment contactor 42. The control may be done via a control valve 56 in the line in which partially/fully consumed scavenger 44a exits the pre-treatment contactor.

### The Pre-Treatment Contactor

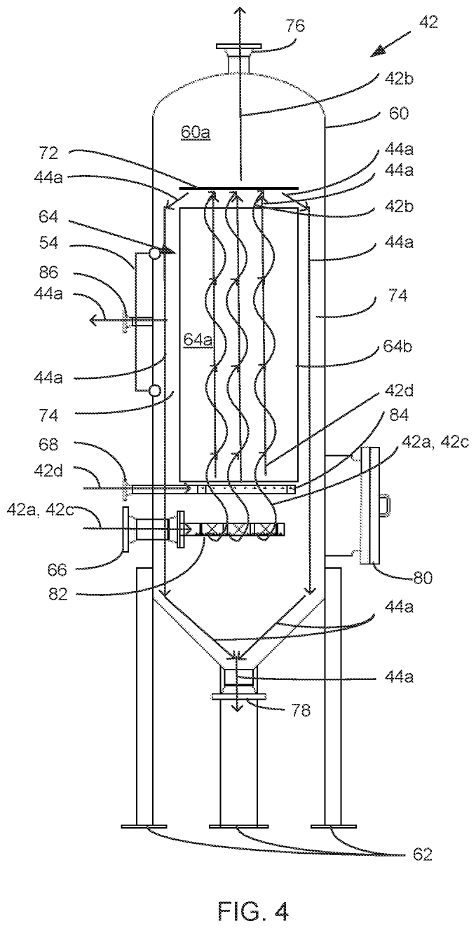

FIG. 4 illustrates one embodiment of a contactor vessel 42 that can be used as the pre-treatment contactor 42 in the pre-treatment system 40 for sweetening natural gas. The contactor vessel 42 comprises an outer wall 60 having a hollow interior 60a and supported by legs 62. There is a first inlet 66, preferably near the bottom of the contactor vessel, that allows the sour gas 42a to enter the vessel. The first inlet 66 may also be used to inject fresh scavenger 42c into the vessel. There is a second inlet 68, also near the bottom of the contactor vessel, that allows partially consumed scavenger 42d to enter the contactor vessel. The first inlet 66 may be connected to a sparger 82 inside the vessel, and the second inlet 68 may be connected to a liquid distributer 84.

Inside the vessel is a contacting member 64 having an inner cavity 64a and a wall 64b. The contacting member 64 may be a tube-shaped member which is preferably positioned above the first and second inlets 66, 68. Natural gas and scavenger contact each other and react in the cavity 64a of the contacting member as they flow upwards through the contacting member cavity 64a.

The vessel also includes a separation member 72 for separating reacted scavenger from the natural gas. In the illustrated embodiment, the separation member 72 is a perforated plate positioned above the contacting member 64. When the partially sweetened gas 42b and partially/fully consumed scavenger 44a reach the separation member 72, the gas 42b flows through the perforations in the plate and out of the vessel 42 via a gas outlet 76, which is preferably located at the top of the vessel.

Inside the vessel 42, there is a channel 74 through which partially/fully consumed scavenger 44a flows after it has been separated from the partially sweetened gas 42b by the separation member 72. In the illustrated embodiment, the channel 74 is the annulus between the wall 60 of the vessel and the wall 64b of the contacting member 64. The partially/fully consumed scavenger 44a flows from the separation member 72 through the channel 74 and out a second outlet 78, which may be a drain located at the bottom of the vessel.

The vessel 42 may include one or more large passageways 80 to allow personnel access to the interior of the vessel for inspection, maintenance, repairs and cleaning. FIG. 4 illustrates one passageway 80 near the bottom of the vessel, however there may also be another passageway near the top of the vessel.

The vessel 42 may also include an auxiliary outlet 86 that can be opened if needed to remove partially consumed scavenger 44a from the vessel to maintain a desired fluid level in the vessel. The opening of the auxiliary outlet 86 may be controlled by the level controller 54.

Use of the vessel 42 as the pre-treatment contactor will now be described with reference to FIG. 4. Sour gas 42a and fresh scavenger 42c enter the first inlet 66 near the bottom of the vessel 42 and flow out of the sparger 82, which may be a gas sparger with downward facing holes. Partially-consumed scavenger 42d enters the second inlet 68 and flows out of the liquid distributor 84, which may have upward facing holes. The sour gas 42a, partially-consumed scavenger 42d and fresh scavenger 42c then mix together as they move up the cavity 64a of the contacting member 64, thereby reacting to remove H₂S from the gas. Upon exiting the contacting member 64, the sour gas has been converted to partially sweetened gas 42b and the scavenger 42d, 42c has been converted to partially and/or fully consumed scavenger 44a. Upon contacting the separation member 72, the partially-sweetened gas 42b flows through the perforations in the plate and out the gas outlet 76 at the top of the vessel. The partially and/or fully consumed scavenger 44a is redirected by the plate to the channel 74, where it flows down the annulus between the contacting member wall 64b and the outer wall 60, then out the second outlet 78 where it is then directed into the separation vessel 44. The partially and/or fully consumed scavenger 44a flowing out of the drain is in liquid form but may include solid precipitate from fully consumed scavenger that has already precipitated out. The partially and/or fully consumed scavenger 44a may also flow from the channel 74 out the auxiliary outlet 86 into the separation vessel 44.

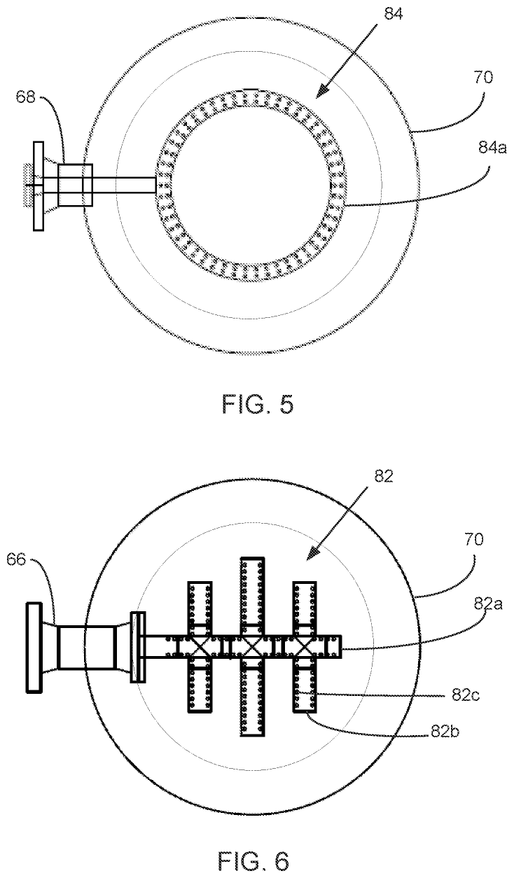

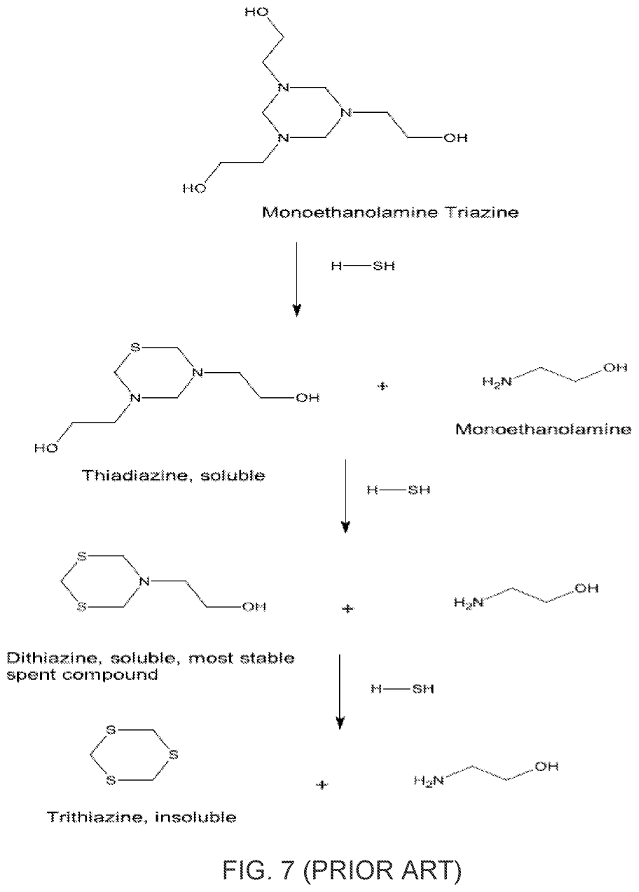

FIG. 5 illustrates a top view of one embodiment of the second inlet 68 and liquid distributor 84 inside the vessel 42. In this embodiment, the liquid distributer 84 comprises a perforated ring 84a having perforations on the upper side of the ring. Other shapes and configurations for the liquid distributer can be used.

FIG. 6 illustrates a bottom view of one embodiment of the first inlet 66 and sparger 82 inside the vessel 42. In this embodiment, the sparger 82 is a gas distribution system, which has a central body 82a with a plurality of arms 82b extending outward from the central body. Perforations 82c are on the bottom side of the central body and arms that direct gas and/or liquid flowing out of the sparger toward the bottom of the vessel. Other shapes and configurations for the sparger can be used.

### Retro-Fitting Existing Gas Sweetening Systems

The subject system can be used to retrofit existing gas sweetening systems 30 with the pre-treatment system 40. To do so, the pre-treatment contactor 42 and separation vessel 44 are provided and operatively connected to the existing gas sweetening system as illustrated in FIG. 3. This allows the pre-treatment system to fully consume triazine-based scavengers to the point where trithiazine precipitate is produced, thereby more fully utilizing the scavenger.

Although the present disclosure has been described and illustrated with respect to certain embodiments and uses thereof, it is not to be so limited since modifications and changes can be made therein which are within the full, intended scope of the disclosure as understood by those skilled in the art.

1. A method for removing hydrogen sulfide from natural gas comprising the following steps in any order:
a) reacting a sour natural gas with a partially consumed triazine-based scavenger to produce a partially sweetened natural gas and a partially and/or fully consumed scavenger, wherein in fully consumed scavenger, three reaction sites of triazine molecules have undergone a sulfur molecule substitution to form trithiazine;
b) separating the partially sweetened natural gas from the partially and/or fully consumed scavenger;
c) separating any fully consumed scavenger from the partially and/or fully consumed scavenger, including separating any trithiazine that has precipitated out;
d) reacting the partially sweetened natural gas from step a) with a fresh triazine-based scavenger to produce a sweetened natural gas and a second partially consumed scavenger; and
e) separating the sweetened natural gas from the second partially consumed scavenger.

2. The method of claim 1, wherein the second partially consumed scavenger produced in step d) is used as at least part of the partially consumed triazine-based scavenger for step a).

3. The method of claim 1, wherein an amount of the fresh triazine-based scavenger provided in step d) is controlled based on a hydrogen sulfide concentration of the partially sweetened natural gas to prevent the fresh triazine-based scavenger from being fully consumed when the sweetened natural gas is produced.

4. The method of claim 1, wherein in step a), a second fresh triazine-based scavenger is reacted with the sour natural gas along with the partially consumed triazine-based scavenger.

5. The method of claim 1, wherein after the fully consumed scavenger has been separated from the partially and/or fully consumed scavenger in step c), any remaining partially consumed scavenger is re-used in step a) for reacting with the sour natural gas.

6. A system for removing hydrogen sulfide from natural gas comprising:
a first vessel for receiving a sour natural gas and a partially consumed triazine-based scavenger, wherein the partially consumed triazine-based scavenger reacts with the sour natural gas to produce a partially sweetened natural gas and a partially and/or fully consumed scavenger, wherein in fully consumed scavenger, three reaction sites of triazine molecules have undergone a sulfur molecule substitution to form trithiazine;
a second vessel operatively connected to the first vessel for receiving the partially sweetened natural gas from the first vessel and a fresh triazine-based scavenger, the fresh triazine-based scavenger reacting with the partially sweetened natural gas to produce a sweetened natural gas and a second partially consumed scavenger;
a first separation vessel operatively connected to the first vessel for receiving the partially and/or fully consumed scavenger from the first vessel and separating any fully consumed scavenger, including any trithiazine that has precipitated out from the consumed scavenger;
a scavenger delivery system operatively connected to the first vessel and the second vessel for delivering the partially consumed triazine-based scavenger to the first vessel and the fresh triazine-based scavenger to the second vessel; and
a control system controlling a flow of the fresh triazine-based scavenger to the second vessel based on a hydrogen sulfide concentration in the partially sweetened natural gas to prevent the fresh triazine-based scavenger in the second vessel from being fully consumed when the sweetened natural gas is produced.

7. The system of claim 6, further comprising a second separation vessel operatively connected to the second vessel for receiving and separating the sweetened natural gas and the partially consumed scavenger.

8. The system of claim 6, wherein the sweetened natural gas and the partially consumed scavenger are separated from each other in the second vessel.

9. The system of claim 6, wherein the second partially consumed scavenger produced in the second vessel is introduced into the first vessel as at least part of the partially consumed triazine-based scavenger via the scavenger delivery system.

10. The system of claim 6, wherein the control system comprises a hydrogen sulfide sensor operatively connected between the first vessel and the second vessel for measuring the hydrogen sulfide concentration in the partially sweetened natural gas exiting the first vessel, and wherein the control system is responsive to the hydrogen sulfide concentration exiting the first vessel to increase or decrease the flow of the fresh triazine-based scavenger to the second vessel.

11. The system of claim 6, wherein the first vessel receives a second fresh triazine-based scavenger for reacting with the sour natural gas along with the partially consumed triazine-based scavenger.

12. The system of claim 6, wherein the control system is responsive to the hydrogen sulfide concentration exiting the first vessel to increase or decrease the flow of the partially consumed triazine-based scavenger to the first vessel.

13. The system of claim 6, wherein any partially consumed scavenger in the first separation vessel is recirculated back into the first vessel for further reaction with the sour natural gas.

14. The system of claim 6, wherein the first vessel comprises:
a first inlet for receiving the sour natural gas;
a second inlet for receiving the partially consumed triazine-based scavenger;
a contacting member inside the first vessel, wherein the contacting member includes a cavity for reacting the sour natural gas with the partially consumed triazine-based scavenger;
a separation member inside the first vessel for causing the separation of the partially sweetened natural gas from the partially and/or fully consumed scavenger;
a gas outlet through which the partially sweetened gas exits the first vessel; and
a second outlet through which the partially and/or fully consumed scavenger exits the first vessel.

15. The system of claim 14, wherein the contacting member includes a wall separating the cavity from a channel, wherein the partially and/or fully consumed scavenger flows from the separation member to the second outlet through the channel.

16. The system of claim 15, wherein the contacting member is a tube-shaped member, wherein the cavity is inside the wall and the channel is outside the wall.

17. The system of claim 14, wherein the separation member is a perforated plate.

18. A system for retro-fit connection to an existing gas sweetening system, the system for pre-treating natural gas prior to the natural gas entering the existing gas sweetening system, the system comprising:
a first vessel for operative connection to the existing gas sweetening system, the first vessel for receiving a sour natural gas and a partially consumed triazine-based scavenger, wherein the partially consumed triazine-based scavenger reacts with the sour natural gas to produce a partially sweetened natural gas and a partially and/or fully consumed scavenger, wherein the partially sweetened natural gas is transported to the existing gas sweetening system for further treatment; wherein in fully consumed scavenger, three reaction sites of triazine molecules have undergone a sulfur molecule substitution to form trithiazine;
a first separation vessel operatively connected to the first vessel for receiving the partially and/or fully consumed scavenger from the first vessel and separating any fully consumed scavenger, including trithiazine that has precipitated out from the partially and/or fully consumed scavenger; and
a scavenger delivery system operatively connected to the first vessel for delivering the partially consumed triazine-based scavenger to the first vessel.

19. The system of claim 18, wherein the partially consumed triazine-based scavenger received in the first vessel is received from the existing gas sweetening system where it became partially consumed during operations in the existing gas sweetening system.

20. The system of claim 18, wherein the operative connection of the first separation vessel and the first vessel allows for any partially consumed scavenger from the first separation vessel to be recirculated back to the first vessel for further reaction with the sour natural gas.

21. A method for retrofitting an existing gas sweetening system to include a pre-treatment system, comprising the following steps in any order:
providing a first vessel and operatively connecting the first vessel to the existing gas sweetening system, the first vessel for receiving a sour natural gas and a partially consumed triazine-based scavenger to react the partially consumed triazine-based scavenger with the sour natural gas to produce a partially sweetened natural gas and a partially and/or fully consumed scavenger, wherein in consumed scavenger, three reaction sites of triazine molecules have undergone a sulfur molecule substitution to for trithiazine; and
providing a first separation vessel and operatively connecting the separation vessel to the first vessel, the first separation vessel for receiving the partially and/or fully consumed scavenger and separating any fully consumed scavenger, including trithiazine that has precipitated out from the partially and/or fully consumed scavenger;
wherein the operative connection of the first vessel to the existing gas sweetening system allows for the flow of partially sweetened natural gas from the first vessel to the existing gas sweetening system for further treatment.

22. The method of claim 21, wherein the partially consumed triazine-based scavenger is provided from the existing gas sweetening system.
